(19) United States
(12) Patent Application Publication
(10) Pub. No.: US 2006/0047866 A1
(43) Pub. Date: Mar. 2, 2006

(54) Computer system having direct memory access controller

(76) Inventor: Atsushi Yamazaki, Tokyo (JP)

Correspondence Address: RABIN & BERDO, P.C., Suite 500, 1101 14th Street, Washington, DC, 20005, US

(21) Appl. No.: 11/080,462

(22) Filed: Mar. 16, 2005

(30) Foreign Application Priority Data
Aug. 24, 2004 (JP) 2004-243454

(51) Int. Cl. G06F 13/28

(52) U.S. Cl. 710/22

(57) ABSTRACT

A computer system which includes a DMAC that can control a transfer rate when data is transferred within a memory. The computer system is provided with a variable pulse generation unit, connected to a system bus, for generating a pulse signal having a period and a pulse width that are specified by a CPU. In the case of controlling data transfer between the first and second areas within the memory, the DMAC selects the pulse signal generated by the variable pulse generation unit by means of a selector, thereby controlling the data transfer within the memory in accordance with the timing of the pulse signal. By appropriately setting the period of the pulse signal, long-time use of the system bus by the data transfer within the memory can be eliminated. Thus, it is possible to reduce adverse effect of the use of the system bus by the data transfer within the memory on another task that is executed in parallel.

### BACKGROUND OF THE INVENTION

1. Field of the Invention

The present invention relates to a computer system including a direct memory access control circuit (hereinafter, referred to as “DMAC”) for directly moving data between a peripheral and a memory or between memories without involving a central processing unit (hereinafter, referred to as “CPU”).

2. Description of the Related Art

FIG. 1 is a schematic diagram of the configuration of a conventional computer system.

The computer system includes a CPU 1, a memory 2, a peripheral 3, and the like that are connected via a system bus 4, and also includes a DMAC 10 for moving data between the memory 2 and the peripheral 3 or between different storage areas within the memory 2.

The DMAC 10 includes a control unit 11, connected to the system bus 4, for receiving a control instruction from the CPU 1 and sending and receiving data via the system bus 4. To the control unit 11 are connected a read address register 12 for holding a read address from which data is to be read, a write address register 13 for holding a write address to which data is to be written, a counter 14 for counting down the number of data pieces every time a data piece is transferred, and a buffer 15 for temporarily holding data to be transferred.

The DMAC 10 further includes a request signal generation unit 16 that generates a request signal ARQ indicating a timing of moving data in the case of data transfer between different storage areas in the memory 2. The request signal ARQ output from the request signal generation unit 16 is supplied to a terminal A of a selector 17. To a terminal B of the selector 17, a request signal REQ from the peripheral 3 is supplied. The selector 17 selects the terminal A when a selection signal SEL supplied from the control unit 11 specifies data moving between the memories, and selects the terminal B when the selection signal SEL specifies data moving between the memory and the peripheral, thereby supplying the request signal corresponding to the selected terminal to the control unit 11.

The control unit 11 outputs a clear signal CLR for canceling the request signal REQ to the peripheral 3, after receiving data based on the request signal REQ or ARQ.

Next, an exemplary operation is described.

In the case of writing data output from the peripheral 3 into the memory 2 by means of the DMAC 10 based on a control instruction from the CPU 1, for example, the control unit 11 sets the address of the peripheral 3 into the read address register 12 and sets the top address of a predetermined storage area in the memory 2 into the write address register 13. The control unit 11 also sets the number of data pieces that are to be transferred in the counter 14 and then selects the terminal B of the selector 17 by the selection signal SEL.

When data to be output is prepared in the peripheral 3 and the request signal REQ is output, the control unit 11 of the DMAC 10 outputs the address of the peripheral 3 to the system bus 4 and permits the peripheral 3 to output the data. In addition, the control unit 11 reads the data output to the system bus 4 and stores the thus read data in the buffer 15.

Then, the control unit 11 outputs the address stored in the write address register 13 and the data stored in the buffer 15 to the system bus 4, and also outputs a write enable signal to the memory 2. At the same time, the control unit 11 outputs the clear signal CLR to the peripheral 3. In this manner, the data output from the peripheral 3 is written onto the top address of the predetermined storage area in the memory 2. Then, the control unit 11 increments the address set in the write address register 13 by one and decrements the value of the counter 14 by one. This operation is repeated until the value of the counter 14 becomes zero.

On the other hand, in the case where copy of data from the first area to the second area within the memory 2 is instructed, the control unit 11 sets the top address of the first area into the read address register 12, sets the top address of the second area into the write address register 13, and sets the number of data pieces that are to be transferred in the counter 14. Then, the control unit 11 selects the terminal A of the selector 17 by the selection signal SEL. Thus, the request signal ARQ is output from the request signal generation unit 16 with a predetermined fixed period.

The control unit 11 outputs the address set in the read address register 12 to the system bus 4 in accordance with the request signal ARQ, and permits the memory 2 to output the data. In addition, the control unit 11 reads the data output to the system bus 4 and stores the read data into the buffer 15. Then, the control unit 11 outputs the address stored in the write address register 13 and the data stored in the buffer 15 to the system bus 4, and also outputs a write enable signal to the memory 2. Thus, the data at the top address of the first area in the memory 2 is copied to the top address of the second storage area. Then, the control unit 11 increments the respective addresses set in the read address register 12 and the write address register 13 by one and decrements the value of the counter 14 by one. This operation is repeated in accordance with the timing of the request signal ARQ until the value of the counter 14 becomes zero.

Japanese Patent Kokai No. 5-40727 describes a direct memory access control method for data transfer between a memory and an option unit such as an input and output device. Japanese Patent Kokai No. 2002-183078 describes a data transfer device that transfers data between a storage device and a plurality of transfer devices while controlling a data transfer rate by using a DMAC.

In the case of data transfer within the memory 2, in the DMAC 10, the data is transferred in accordance with the request signal ARQ that is output from the request signal generation unit 16 with a predetermined fixed period. Thus, when the timing of the request signal ARQ is set giving priority to a rapid data transfer over others, the DMAC 10 occupies the system bus 4 until the data moving within the memory 2 is finished. Therefore, an operation of another task that is executed in parallel is stopped in effect, so that it becomes difficult to perform a smooth parallel processing. Moreover, a wrong operation may be caused by time-out and the like in the extreme case.

### SUMMARY OF THE INVENTION

It is an object of the present invention to provide a computer system including a DMAC that can control a transfer rate when data is transferred within a memory 2.

According to the present invention, a computer system is provided in which a CPU, a memory, and a peripheral are connected to a common system bus and which includes a DMAC for controlling data transfer between the memory and the peripheral or between a first area and a second area within the memory by using the system bus without involving the CPU in accordance with an instruction from the CPU. The computer system also includes a variable pulse generation unit, connected to the system bus, for generating a pulse signal having a period and a pulse width that are specified by the CPU. In the computer system, the DMAC is arranged to control the data transfer between the first and second areas within the memory in accordance with the pulse signal generated by the variable pulse generation unit.

According to the present invention, the variable pulse generation unit for generating the pulse signal having a period and a pulse width that are specified by the CPU is provided, and the data transfer between the first and second areas within the memory is controlled in accordance with the timing of the pulse signal generated by that variable pulse generation unit. Therefore, by appropriately setting the period of the pulse signal, long-term use of the system bus by the data transfer within the memory can be eliminated. Thus, it is possible to reduce the possibility that the data transfer within the memory adversely affects on another task that is executed in parallel.

### BRIEF DESCRIPTION OF THE DRAWINGS

FIG. 1 is a schematic diagram of the configuration of a conventional computer system.

FIG. 2 is a schematic diagram of the configuration of a computer system according to a first embodiment of the present invention.

FIG. 3 is a timing chart of a copy operation for copying data within a memory 2 in FIG. 2.

FIG. 4 is a schematic diagram of the configuration of a computer system according to a second embodiment of the present invention.

FIG. 5 is a timing chart of a copy operation for copying data within the memory 2 in FIG. 4.

### DETAILED DESCRIPTION OF THE INVENTION

In the system, a variable pulse generation unit, an up-down counter, and a comparator are provided. The variable pulse generation unit is connected to a system bus, and generates a pulse signal with a period instructed by a CPU. The up-down counter increases a count value when the pulse signal is supplied, decreases the count value when a clear signal is supplied, and resets the count value when a reset signal is supplied. The comparator outputs a transfer request signal when the count value is equal to or larger than one. A DMAC outputs the reset signal prior to control of data transfer between the first and second areas within a memory. After the control of the data transfer has been started, the DMAC performs control processes for reading data from an address of the first area in the memory and writing the read data to a corresponding address of the second area, as long as the system bus is in a state other than a busy state and the transfer request signal is being supplied. The DMAC also outputs the clear signal every time a data piece is transferred.

The above and other objects and novel features will be more apparent when the description of the preferred embodiments set forth below is read with reference to the drawings attached thereto. It should be noted that the drawings are only intended to explain the invention but are not intended to limit the scope of the invention.

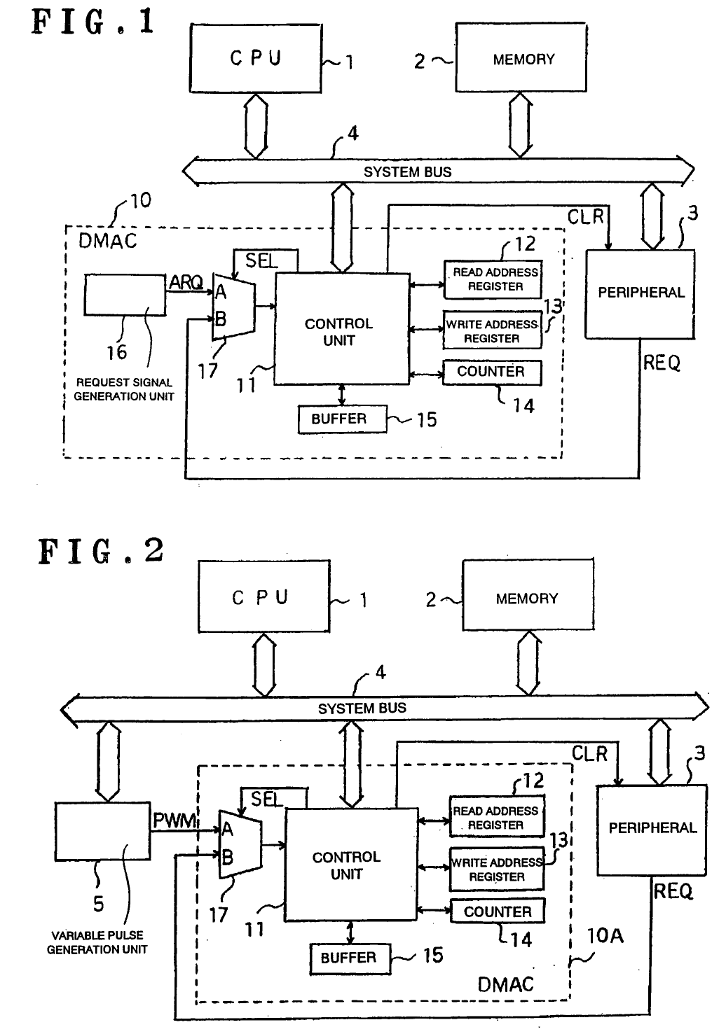

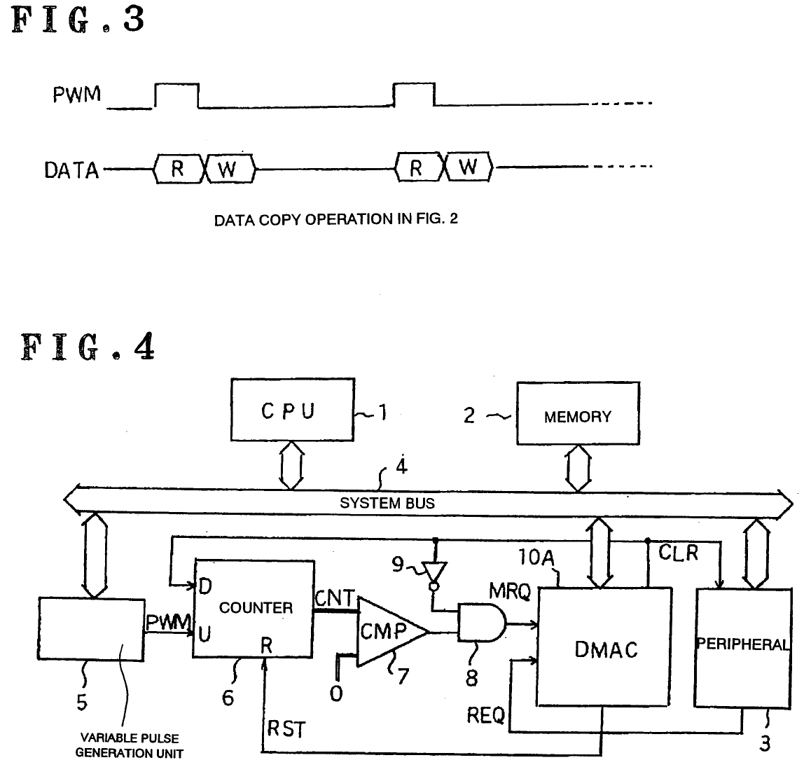

FIG. 2 is a schematic diagram of the configuration of the computer system according to a first embodiment of the present invention. In FIG. 2, the same components as those in FIG. 1 are labeled with the same reference numerals as those in FIG. 1.

In the computer system, a CPU 1, a memory 2, a peripheral 3, and the like are connected via a system bus 4. The computer system includes a DMAC 10A for moving data between the memory 2 and the peripheral 3 or between different storage areas within the memory 2. The computer system further includes a variable pulse generation unit 5 for generating a continuous pulse signal PWM having a given period and a given pulse width in accordance with specification by the CPU 1.

The DMAC 10A includes a control unit 11 that is connected to the system bus 4 so as to receive a control instruction from the CPU 1 and move data via the system bus 4. To the control unit 11, a read address register 12 for holding a read address from which data is to be read, a write address register 13 for holding a write address onto which data is to be written, a counter 14 for counting down the number of data pieces every time a data piece is transferred, and a buffer 15 for temporarily holding the data to be transferred are connected.

The DMAC 10A further includes a selector 17 that selects the pulse signal PWN output from the variable pulse generation unit 5 in the case of data transfer between different storage areas within the memory 2 and selects a request signal REQ from the peripheral 3 in the case of data transfer between the memory 2 and the peripheral 3. The selector 17 selects a terminal A when data moving within the memory 2 is specified by a selection signal SEL supplied from the control unit 11 and selects a terminal B when data moving between the memory 2 and the peripheral 3 is specified by the selection signal SEL, thereby supplying a timing signal corresponding to the selected terminal (i.e., the pulse signal PWM or the request signal REQ) to the control unit 11.

After receiving data based on the request signal REQ or the pulse signal PWM, the control unit 11 outputs a clear signal CLR for canceling the request signal REQ or the like. The DMAC 10A further includes a bus arbitration unit that suppresses start of a data moving operation in a busy state BUSY, i.e., a state where the system bus 4 is being used by another DMAC or the like, although the bus arbitration unit is not shown in the drawings.

FIG. 3 is a timing chart of a copy operation for copying data within the memory 2 shown in FIG. 2. Referring to FIG. 3, the operation of the computer system shown in FIG. 2 is now described.

The CPU 1 controls the variable pulse generation unit 5 to generate a continuous pulse signal PWM having a predetermined period and a predetermined pulse width. The predetermined period is longer than the minimum access time of the memory 2 so as to prevent the data transfer within the memory 2 from occupying the system bus 4 and the predetermined pulse width is a pulse width that can be surely detected as a timing signal by the control unit 11. In this manner, the pulse signal PWM having a relatively long period is continuously supplied from the variable pulse generation unit 5 to the DMAC 10A.

Then, the CPU 1 instructs the DMAC 10A to copy data from the first area to the second area within the memory 2. The control unit 11 of the DMAC 10A sets the top address of the first area into the read address register 12, sets the top address of the second area into the write address register 13, and sets the number of data pieces that are to be transferred in the counter 14. Then, the DMAC 10A selects the terminal A of the selector 17 by the selection signal SEL. Thus, the pulse signal PWM is supplied to the control unit 11 as a timing signal for data moving.

The control unit 11 outputs the address set in the read address register 12 to the system bus 4 in accordance with the pulse signal PWM and permits the memory 2 to output data. In addition, the control unit 11 reads the data output to the system bus 4 and stores the read data in the buffer 15. Then, the control unit 11 outputs the address set in the write address register 13 and the data stored in the buffer 15 to the system bus 4 and outputs a write enable signal to the memory 2. Thus, the data at the top address of the first area in the memory 2 is copied to the top address of the second area. Then, the control unit 11 increments the respective addresses set in the read address register 12 and the write address register 13 by one and decrements the value of the counter 14 by one. This operation is repeated in accordance with the timing of the pulse signal PWM until the value of the counter 14 becomes zero.

In the case where the system bus 4 is being used by another DMAC or the like, i.e., is in the busy state BUSY, the pulse signal PWM is ignored and data moving is not performed. However, when the use of the system bus 4 by the other DMAC or the like is finished and the busy state BUSY is lifted during a period in which the pulse signal PWM is output, the data moving operation is started at that time.

A data moving operation between the memory 2 and the peripheral 3 by the DMAC 10A is the same as that by the conventional DMAC 10.

As described above, the computer system of the first embodiment includes the variable pulse generation unit 5 for generating a continuous pulse signal PWM having a given period and a given pulse width in accordance with specification by the CPU 1, and supplies that pulse signal PWM as a timing signal for the DMAC 10A in the case of data transfer within the memory 2. Therefore, by appropriately setting the period of the pulse signal PWM, an advantageous effect that the rate of transfer within the memory 2 can be controlled is achieved.

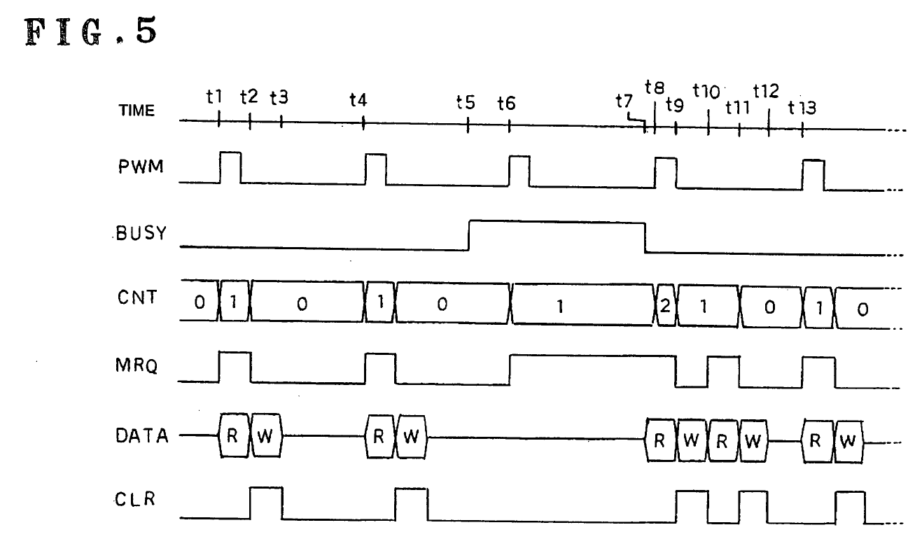

FIG. 4 is a schematic diagram of the configuration of the computer system according to a second embodiment of the present invention. In FIG. 4, the same components as those in FIG. 1 are labeled with the same reference numerals as those in FIG. 1.

In this computer system, a counter 6, a comparator (CMP) 7, and an AND gate (hereinafter, referred to as “AND”) 8 are provided between the output of the variable pulse generation unit 5 and the DMAC 10A. The counter 6 is an up-down type, and increments its count value CNT by one when the pulse signal PWM is supplied to its terminal U from the variable pulse generation unit 5 and decrements its count value CNT by one when the clear signal CLR is supplied to its terminal D from the DMAC 10A. The counter 6 is reset by the reset signal RST at the start of the operation of the DMAC 10A.

The comparator 7 compares the count value CNT of the counter 6 with zero, and outputs a signal of level “H” when the count value CNT is equal to or larger than one and outputs a signal of level “L” when the count value CNT is equal to or smaller than zero. The output of the comparator 7 is connected to one input of the AND 8. To the other input of the AND 8, the clear signal CLR of the DMAC 10A is supplied via an inverter 9. From the output of the AND 8, a request signal MRQ is output and supplied to the DMAC 10A. Except for the above, the configuration is the same as that in FIG. 2.

FIG. 5 is a timing chart of a copy operation for copying data within the memory 2 shown in FIG. 4. Referring to FIG. 5, the operation of the computer system shown in FIG. 4 is now described.

As in the first embodiment, the CPU 1 controls the variable pulse generation unit 5 to generate a continuous pulse signal PWM having a predetermined period and a predetermined pulse width. Thus, the pulse signal PWM having a relatively long period is supplied to the terminal U of the counter 6 from the variable pulse generation unit 5.

Then, the CPU 1 instructs the DMAC 10A to copy data from the first area to the second area within the memory 2. The control unit 11 of the DMAC 10A sets the top address of the first area into the read address register 12, sets the top address of the second area into the write address register 13, and sets the number of data pieces that are to be transferred in the counter 14. Then, the control unit 11 selects the terminal A of the selector 17 by the selection signal SEL. Thus, the pulse signal PWM is supplied to the control unit 11 as a timing signal for data moving. Moreover, the DMAC 10A resets the counter 6 by the reset signal RST. Thus, the count value CNT of the counter 6 becomes zero.

At time t1 in FIG. 5, when the variable pulse generation unit 5 outputs the pulse signal PWM, the count value CNT of the counter 6 becomes one and the output signal of the comparator 7 becomes “H.” At that time, the clear signal CLR of the DMAC 10A is “L.” Therefore, the request signal MRQ output from the AND 8 is “H.” If the busy state BUSY of the system bus 4 is “L” at that time, the control unit 11 of the DMAC 10A outputs the address set in the read address register 12 to the system bus 4 in accordance with the request signal MRQ and permits the memory 2 to output data. In addition, the control unit 11 reads the data output to the system bus 4 and stores the read data in the buffer 15.

At time t2, the control unit 11 changes the level of the clear signal CLR to “H.” Thus, the count value CNT becomes zero and the request signal MRQ becomes “L.” In addition, the control unit 11 outputs the address stored in the write address register 13 and the data stored in the buffer 15 to the system bus 4, and outputs a write enable signal to the memory 2. Thus, the data at the top address of the first area in the memory 2 is written to the top address of the second area.

At time t3, the control unit 11 increments the respective addresses set in the read address register 12 and the write address register 13 by one and decrements the value of the counter 14 by one. The control unit 11 also returns the level of the clear signal CLR to “L.” Thus, preparation of the next data transfer is finished.

At time t4, when the next pulse signal PWM is output, the same operations as those performed at times t1 to t3 are performed for the second addresses of the first and second areas in the memory 2.

It is assumed that the busy state BUSY of the system bus 4 becomes “H” at time t5.

At time t6, when the pulse signal PWM is output, the count value CNT becomes one and the request signal MRQ becomes “H.” However, since the busy state BUSY is “H,” the data moving operation by the control unit 11 is suppressed.

At time t7, when the busy state BUSY is lifted and becomes “L,” the data moving operation by the control unit 11 is started, so that data is read from the first area in the memory 2 via the system bus 4.

At time t8 during the data reading, when the pulse signal PWM is output, the count value CNT is increased to two.

At time t9, when the data reading is finished and data writing into the second area is started, the count value CNT is decreased to one by the clear signal CLR of “H” output from the control unit 11. At this time, the request signal MRQ output from the AND 8 is “L” although the output signal of the comparator 7 is “H.”

At time t10, when the data writing into the second area is finished, the clear signal CLR becomes “L” and the request signal MRQ becomes “H” again. Thus, the data moving operation by the control unit 11 continues, and the data reading from the first area in the memory 2 is performed via the system bus 4.

At time t11, when the data reading from the first area is finished, the clear signal CLR is changed to “H” and the data writing to the second area is started. Thus, the count value CNT becomes zero and the request signal MRQ becomes “L.”

At time t12, when the data writing into the second area is finished, the clear signal CLR becomes “L.” At this time, since the count value CNT is zero, the request signal MRQ is “L” and no data moving operation by the control unit 11 is performed.

At time t13, when the pulse signal PWM is output, the same operation as that performed at time t1 is performed. This operation is repeated until the number of data pieces set in the counter 14 of the DMAC 10A becomes zero.

As described above, the computer system of the second embodiment includes the variable pulse generation unit 5 that is the same as that in the first embodiment and the counter 6 for counting the difference between the number of the pulse signals PWM as the data transfer request signal and the number of the clear signals CLR that are signals for which data transfer has been actually performed. The computer system continuously performs data transfer independently of the pulse signal PWM until the count value CNT of the counter 6 becomes zero. Thus, in the case where the data transfer is suppressed because of conflict in the system bus 4, the data transfer is continuously performed at a time when the conflict is eliminated. Therefore, the second embodiment achieves an advantageous effect that delay of the data transfer caused by conflict in the bus can be reduced, in addition to the advantageous effects of the first embodiment.

The variable pulse generation unit 5 in the second embodiment is not necessarily arranged to control the pulse width, unlike the first embodiment. That is, the variable pulse generation unit 5 in the second embodiment needs only generate a pulse signal PWM having a given period. Therefore, a simple timer or the like can be used as that variable pulse generation unit 5.

This application is based on Japanese Patent Application No. 2004-243454 which is herein incorporated by reference.

What is claimed is:

1. A computer system including a central processing unit, a memory, and a peripheral that are connected to a common system bus and including a direct memory access control circuit for controlling data transfer between the memory and the peripheral or between a first area and a second area within the memory by using the system bus without involving the central processing unit in accordance with an instruction from the central processing unit, the system comprising:
a variable pulse generation unit, connected to the system bus, for generating a pulse signal having a period and a pulse width that are specified by the CPU, wherein
the direct memory access control circuit controls the data transfer between the first area and the second area within the memory in accordance with the pulse signal generated by the variable pulse generation unit.

2. A computer system including a central processing unit, a memory, and a peripheral that are connected to a common system bus and including a direct memory access control circuit for controlling data transfer between the memory and the peripheral or between a first area and a second area within the memory by using the system bus without involving the central processing unit in accordance with an instruction from the central processing unit, the system comprising:
a variable pulse generation unit, connected to the system bus, for generating a pulse signal with a period specified by the central processing unit;
an up-down counter for increasing a count value when the pulse signal is supplied, decreasing the count value when a clear signal is supplied, and resetting the count value when a reset signal is supplied; and
a comparator for outputting a transfer request signal when the count value is equal to or larger than one, wherein
the direct memory access control circuit outputs the reset signal prior to control of the data transfer between the first area and the second area within the memory, and, after start of the control of the data transfer, performs control for reading data from an address of the first area and writing the read data into a corresponding address of the second area as long as the system bus is in a state other than a busy state and the transfer request signal is being supplied, and outputs the clear signal every time a data piece is transferred.
